(19) United States
(12) Patent Application Publication
(10) Pub. No.: US 2016/0090313 A1
(43) Pub. Date: Mar. 31, 2016

(54) FILTER CARTRIDGE AND A METHOD FOR FORMING A FILTER MEDIUM

(71) Applicant: General Electric Company, Schenectady, NY (US)

(72) Inventors: Timothy Scott Shaffer, La Grange, KY (US); Brian Christopher Moore, Mechanicville, NY (US); Doo Young Kim, Lexington, KY (US)

(21) Appl. No.: 14/502,080

(22) Filed: Sep. 30, 2014

(51) Int. Cl. C02F 1/28; B01J 21/18; B29C 70/58

(52) U.S. Cl. CPC C02F 1/283; B29C 70/58; B01J 21/18; C02F 2101/16

(57) ABSTRACT

A method for forming a filter medium includes mixing activated carbon and nitrogen enriched plastic binder. The activated carbon and nitrogen enriched plastic binder are heated in order to bind the activated carbon to the nitrogen enriched plastic binder and form a filter medium block. A related filter cartridge is also provided.

### FIELD OF THE INVENTION

The present subject matter relates generally to water filter media, such as activated carbon blocks.

Water filters are generally provided with a filtering medium, such as a block of activated carbon, that removes contaminants from water prior to delivering such water to a user. Activated carbon blocks have pores that permit water flow through the carbon blocks. By passing through the pores, contaminants such as sand, rust, and cysts within the flow of water can be mechanically filtered out of the water. Similarly, volatile organic compounds such as chloroform, lindane, and atrazine can be removed by being adsorbed into porous surfaces as water moves through the carbon blocks.

Activated carbon blocks can also remove chloramine from water flowing therethrough. However, chloramine reduction with activated carbon poses certain challenges. Generally, activated carbon requires extended exposure time to reduce chloramine within water, and extended exposure times can be inconvenient. Catalytic activated carbon can significantly reduce the exposure time needed for chloramine reduction. However, the process to generate catalytic activated carbon can be time consuming and expensive.

Various methods are available to treat activated carbon and form catalytic activated carbon. For example, U.S. Pat. No. 5,356,849 to Matviya et al., U.S. Pat. No. 6,699,393 to Baker et al., and U.S. Pat. No. 7,361,280 to Baker, all of which are incorporated by reference herein in their entireties, describe processes for forming catalytic activated carbon that generally include oxidizing a nitrogen-poor carbon material in order to form oxidized char and exposing the oxidized char to a nitrogen-containing compound while the oxidized char is heated to a high temperature, e.g., between 850° C. and 950° C. Such oxidizing and heating can be expensive and time-consuming.

Accordingly, a water filter assembly with features for reducing chloramine would be useful. In particular, a water filter assembly with an activated carbon block and features assisting with reducing chloramine that does not require catalytic activated carbon would be useful.

### BRIEF DESCRIPTION OF THE INVENTION

The present subject matter provides methods for forming filter media which are efficient for removing chloramine. The methods include mixing activated carbon and nitrogen enriched plastic binder. The activated carbon and nitrogen enriched plastic binder are heated in order to bind the activated carbon to the nitrogen enriched plastic binder and form a filter medium block. A related filter cartridge is also provided. Additional aspects and advantages of the invention will be set forth in part in the following description, or may be apparent from the description, or may be learned through practice of the invention.

In a first exemplary embodiment, a method for forming a filter medium is provided. The method includes providing activated carbon and nitrogen enriched plastic binder, mixing the activated carbon and the nitrogen enriched plastic binder, and heating the activated carbon and the nitrogen enriched plastic binder. The activated carbon is bound to the nitrogen enriched plastic binder after the step of heating such that the activated carbon and the nitrogen enriched plastic binder form a filter medium block.

In a second exemplary embodiment, a filter cartridge is provided. The filter cartridge includes a casing that defines an interior volume. A filter medium is positioned within the interior volume of the casing. The filter medium includes activated carbon dispersed within a plastic binder. The plastic binder includes at least one of polyurethane and urea formaldehyde.

In a third exemplary embodiment, a method for forming a filter medium is provided. The method includes blending nitrogen containing plastic resin with a binder material to form a nitrogen enriched binder, mixing the nitrogen enriched binder with activated carbon, and heating the nitrogen enriched binder and activated carbon. The activated carbon is coupled to the nitrogen enriched binder after the step of heating such that the activated carbon and the nitrogen enriched binder form a filter medium block.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water filter assembly according to an exemplary embodiment of the present subject matter.

FIG. 2 provides a section view of a filter cartridge of the exemplary water filter assembly of FIG. 1.

FIG. 3 illustrates a method for forming a filter medium according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

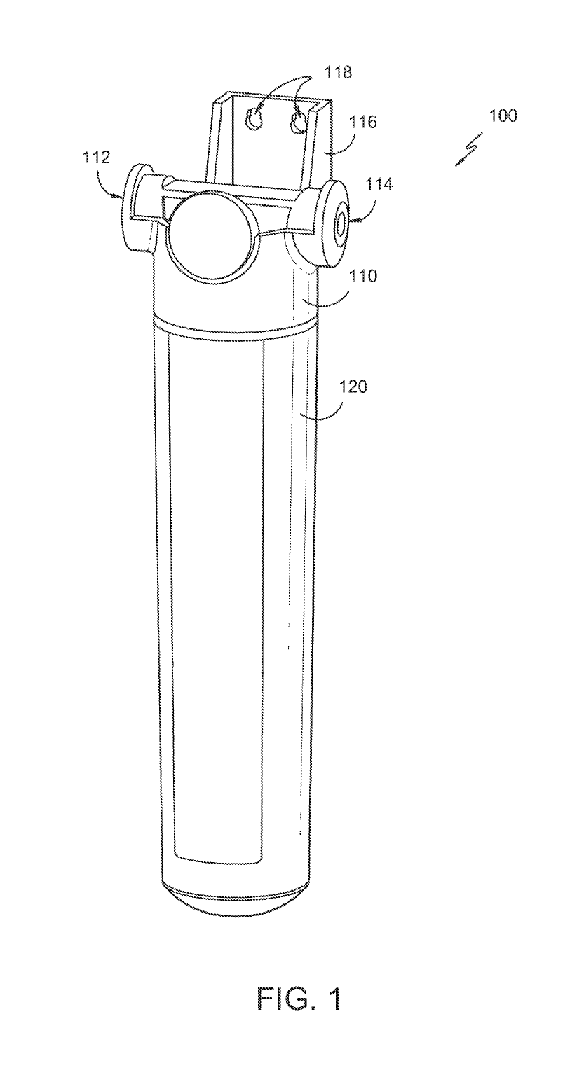

FIG. 1 provides a perspective view of a water filter assembly 100 according to an exemplary embodiment of the present subject matter. Water filter assembly 100 may be used be used to filter water at any suitable location. For example, water filter assembly 100 may be as a point of use water filtration system, e.g., installed beneath a sink, or as a point of entry water filtration system for an entire building. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water filter assembly 100 includes a manifold 110 and a water filter cartridge 120 removably mounted to manifold 110. Manifold 110 includes a mounting bracket 116 that defines holes 118. Fasteners (not shown) such as nails, pegs, tabs, screws, or bolts may be inserted through holes 118 to mount water filter assembly 100, e.g., to a kitchen cabinet beneath a kitchen sink or to a wall within a house. Manifold 110 also defines an entrance 112 and an exit 114. Entrance 112 may be in fluid communication with a water supply and receive unfiltered water from the water supply. From entrance 112, such unfiltered water is directed into water filter cartridge 120. Such unfiltered water passes through water filter cartridge 120 and exits manifold 110 at exit 114 as filtered water. Such filtered water may be directed, e.g., to an ice maker within a refrigerator, a kitchen sink faucet, and/or any other suitable use.

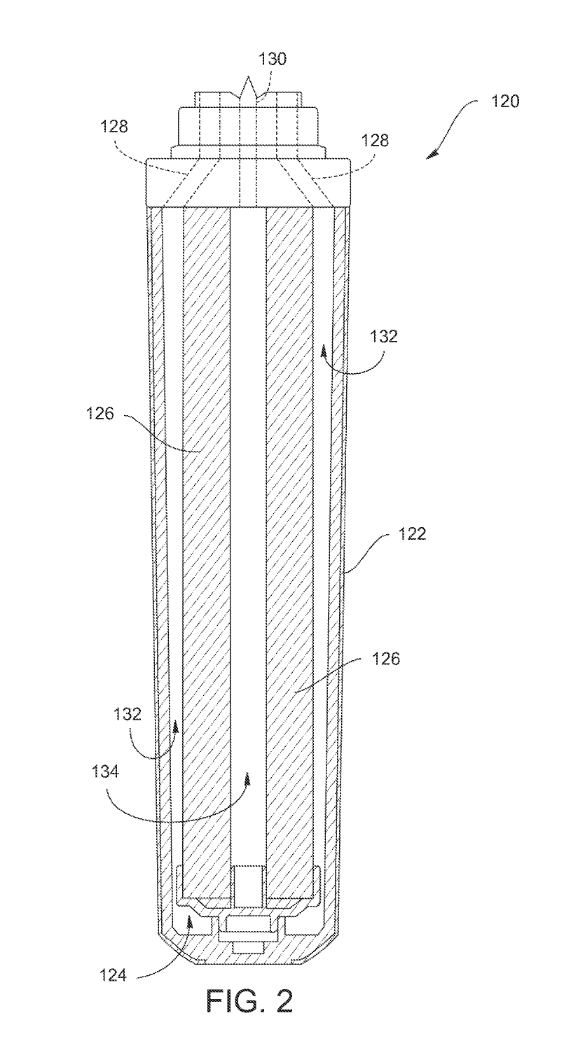

FIG. 2 provides a section view of water filter cartridge 120. As may be seen in FIG. 2, water filter cartridge 120 includes a casing 122 that defines a chamber 124. Water filter cartridge 120 defines an inlet passage 128 and an outlet passage 130, e.g., at a top portion of water filter cartridge 120. Inlet passage 128 is in fluid communication, e.g., extends between, entrance 112 of manifold 110 (FIG. 1) and chamber 124 of casing 122. Thus, unfiltered water may flow from entrance 112 of manifold 110 into chamber 124 of casing 122 via inlet passage 128 of water filter cartridge 120. Outlet passage 130 is in fluid communication, e.g., extends between, chamber 124 of casing 122 and exit 114 of manifold 110. Thus, filtered water may flow from chamber 124 of casing 122 to exit 114 of manifold 110 via outlet passage 130 of water filter cartridge 120.

A filter medium 126 is disposed within chamber 124. Filter medium 126 may be spaced apart from an inner surface of casing 122 as shown in FIG. 2. Filter medium 126 divides chamber 124 of casing 122 into an unfiltered volume 132 and a filtered volume 134. Filter medium 126 may reduce impurities and contaminants in water passing through filter medium 126 from unfiltered volume 132 of water filter cartridge 120 to filtered volume 134 of water filter cartridge 120. In particular, filter medium 126 includes activated carbon for reducing impurities and contaminants in water passing through filter medium 126, as discussed in greater detail below. As will be understood by those skilled in the art, water filter assembly 100 may include additional filter media that filter water entering chamber 124. Thus, unfiltered volume 132 of water filter cartridge 120 may be filtered relative to other filter media but not filter medium 126.

As an example, water passing through water filter cartridge 120 can follow a path through water filter cartridge 120. In particular, unfiltered water can enter water filter cartridge 120 through inlet passage 128 of water filter cartridge 120. Such unfiltered water may flow though inlet passage 128 of water filter cartridge 120 into unfiltered volume 132 of chamber 124. Such unfiltered water can pass though filter medium 126 to reduce impurities and can exit filter medium 126 into filtered volume 134 of water filter cartridge 120 as filtered water. Such filtered water may then pass or flow through outlet passage 130 of water filter cartridge 120 out of water filter cartridge 120.

In such a manner, unfiltered water can follow the path through water filter cartridge 120. In particular, unfiltered water can pass though filter medium 126, and filtered water can exit water filter cartridge 120. Such filtering can improve taste and/or reduce harmful contaminants in water and/or remove other compounds as desired by an end user.

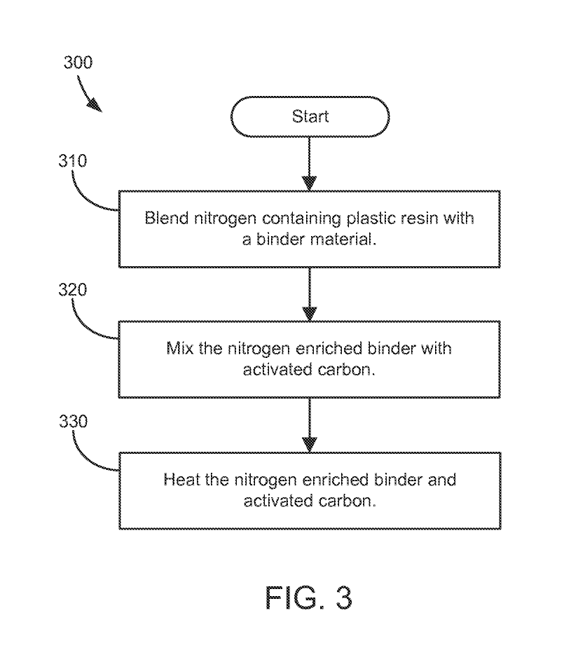

FIG. 3 illustrates a method 300 for forming a filter medium according to an exemplary embodiment of the present subject matter. Method 300 may be used to form any suitable filter medium. For example, method 300 may be used to form filter medium 126 of water filter cartridge 120 (FIG. 2). Thus, method 300 is described in greater detail below in the context of filter medium 126. However, it should be understood that method 300 may be used to form any suitable filter medium. Utilizing method 300, a performance of filter medium 126 may be improved. In particular, method 300 may assist filter medium 126 with providing desired or prescribed chloramine reduction from water passing therethrough, as discussed in greater detail below.

At step 310, nitrogen containing plastic resin is blended or mixed with a binder material to form a nitrogen enriched binder. The nitrogen containing plastic resin may be any suitable nitrogen containing plastic resin. For example, the nitrogen containing plastic resin may include polyurethane, urea formaldehyde or combinations thereof. In a similar manner, the binder material may be any suitable material. For example, the binder material may include polyethylene. It should be understood that in certain exemplary embodiments, the nitrogen containing plastic resin need not be mixed with the binder material at step 310. Thus, the nitrogen enriched binder may be formed with only nitrogen containing plastic resin, in certain exemplary embodiments.

At step 320, the nitrogen enriched binder is blended or mixed with activated carbon. It should be understood that the activated carbon and nitrogen enriched binder may be mixed at any suitable time. For example, activated carbon may be mixed with the nitrogen containing plastic resin and/or the binder material prior to or during step 310. The activated carbon may include catalytic activated carbon in any suitable amount. It is also noted that at step 320, additives, such as metal scavengers, may be included with the carbon. The metal scavengers may include, e.g. titanium dioxide, zeolite, activated alumina, etc. Moreover, the present subject matter may also be used with other filter media besides carbon that can provide a desired trait to the water.

Any suitable amount of nitrogen enriched binder may be mixed with activated carbon at step 320. For example, after step 320, the mixture of nitrogen enriched binder and activated carbon may include equal to or greater than sixty percent activated carbon by weight and less than or equal to ninety percent activated carbon by weight. Similarly, the mixture of nitrogen enriched binder and activated carbon may include more than ten percent nitrogen enriched binder by weight and less than forty percent nitrogen enriched binder by weight step 320.

At step 330, the mixture of nitrogen enriched binder and activated carbon is heated, e.g., to the softening point of the nitrogen enriched binder. For example, the nitrogen enriched binder and the activated carbon may be sintered together at step 330 within a heated mold. The activated carbon is coupled to the nitrogen enriched binder after step 330. In such a manner, the activated carbon and the nitrogen enriched binder may form a filter medium block, e.g., shaped like filter medium 126, after step 330.

After step 330, the filter medium block may be positioned within casing 122 of water filter cartridge 120. In addition, water may be directed through the filter medium block within filter cartridge 120, e.g., in the manner described above. The filter medium block removes chloramine from the water flowing through the filter medium block within water filter cartridge 120. In particular, nitrogen from the nitrogen containing plastic resin within the filter medium block reacts with chloramine from the water flowing through the filter medium block in order to assist with removing the chloramine from the water.

The nitrogen from the nitrogen containing plastic resin may be used in lieu of or in addition to catalytic activated carbon within the filter medium block to achieve chloramine reduction. Thus, filter medium 126 may include no catalytic activated carbon, in certain exemplary embodiments, and filter medium 126 may still remove chloramine from water flowing therethrough efficiently and/or effectively. Thus, it should be understood that the nitrogen from the nitrogen containing plastic resin can enhance the effective reduction of chloramine, e.g., even without catalytic activated carbon. Testing has shown that the nitrogen from the nitrogen containing plastic resin provides equal chloramine to current filters using only catalytic activated carbon. However, in alternative exemplary embodiments, the nitrogen from the nitrogen containing plastic resin may supplement or augment chloramine reduction with catalytic activated carbon in filter medium 126.

Without wishing to be bound to any particular theory, it is believed that activated carbon interacts with chloramine according to the following reactions

NH₂Cl+H₂O+C*→NH₃+CO*+H⁺+Cl⁻

2NH₂Cl+CO*→N₂+C*+H₂O+2H⁺+2Cl⁻.

In addition, without wishing to be bound to any particular theory, it is believed that activated carbon reacts with chloramine according to a third reaction when the activated carbon is provided with nitrogen where the third reaction is

NH₂Cl+H₂O+N*→NH₃+NO*+H⁺+Cl⁻.

Thus, nitrogen from the nitrogen containing plastic resin may assist with reducing chloramine according to the third reaction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for forming a filter medium, comprising:
providing activated carbon and nitrogen enriched plastic binder;
mixing the activated carbon and the nitrogen enriched plastic binder; and
heating the activated carbon and the nitrogen enriched plastic binder, the activated carbon bound to the nitrogen enriched plastic binder after said step of heating such that the activated carbon and the nitrogen enriched plastic binder form a filter medium block.

2. The method of claim 1, wherein the nitrogen enriched plastic binder comprises at least one of polyurethane and urea formaldehyde.

3. The method of claim 2, wherein the nitrogen enriched plastic binder further comprises polyethylene.

4. The method of claim 1, wherein the filter medium block comprises at least sixty percent activated carbon by weight and no more than ninety percent activated carbon by weight after said step of heating.

5. The method of claim 4, wherein the filter medium block comprises at least ten percent nitrogen enriched plastic binder by weight and no more than forty percent nitrogen enriched plastic binder by weight after said step of heating.

6. The method of claim 1, wherein the activated carbon comprises catalytic activated carbon.

7. The method of claim 1, further comprising positioning the filter medium block within a filter cartridge after said step of heating.

8. The method of claim 7, further comprising directing water through the filter medium block within the filter cartridge, the filter medium block removing chloramine from the water flowing through the filter medium block at said step of directing, nitrogen from the nitrogen enriched plastic binder reacting with chloramine from the water flowing through the filter medium block at said step of directing.

9. A filter cartridge, comprising:
a casing defining an interior volume;
a filter medium positioned within the interior volume of the casing, the filter medium comprising activated carbon dispersed within a plastic binder, the plastic binder comprising at least one of polyurethane and urea formaldehyde.

10. The filter cartridge of claim 9, wherein the plastic binder further comprises polyethylene.

11. The filter cartridge of claim 9, wherein the filter medium comprises no less than sixty percent activated carbon by weight and no more than ninety percent activated carbon by weight.

12. The filter cartridge of claim 9, wherein the filter medium comprises no less than ten percent plastic binder by weight and no more than forty percent plastic binder by weight.

13. The filter cartridge of claim 9, wherein the activated carbon comprises catalytic activated carbon.

14. The filter cartridge of claim 9, wherein the filter medium is configured for removing chloramine from water flowing through the filter medium with nitrogen from the plastic binder.

15. A method for forming a filter medium, comprising:
blending nitrogen containing plastic resin with a binder material to form a nitrogen enriched binder;
mixing the nitrogen enriched binder with activated carbon; and
the nitrogen enriched binder and activated carbon, the activated carbon coupled to the nitrogen enriched binder after said step of heating such that the activated carbon and the nitrogen enriched binder form a filter medium block.

16. The method of claim 15, wherein the nitrogen containing plastic resin comprises at least one of polyurethane and urea formaldehyde.

17. The method of claim 15, wherein the binder material comprises polyethylene.

18. The method of claim 15, wherein the filter medium block comprises no less than sixty percent activated carbon by weight and no more than ninety percent activated carbon by weight after said step of heating, the filter medium block comprising more than ten percent nitrogen enriched binder by weight and less than forty percent nitrogen enriched binder by weight after said step of heating.

19. The method of claim 15, wherein the activated carbon comprises catalytic activated carbon.

20. The method of claim 15, further comprising positioning the filter medium block within a filter cartridge after said step of heating, and directing water through the filter medium block within the filter cartridge, the filter medium block removing chloramine from the water flowing through the filter medium block at said step of directing, nitrogen from the nitrogen containing plastic resin reacting with chloramine from the water flowing through the filter medium block at said step of directing.
